(19) United States
(12) Patent Application Publication
(10) Pub. No.: US 2018/0326774 A1
(43) Pub. Date: Nov. 15, 2018

(54) Tradesmen Cards

(71) Applicant: Carl Hofstrom, Knoxville, TN (US)

(72) Inventor: Carl Hofstrom, Knoxville, TN (US)

(21) Appl. No.: 15/963,333

(22) Filed: Apr. 26, 2018

Related U.S. Application Data
(60) Provisional application No. 62/503,406, filed on May 9, 2017.

(51) Int. Cl. B42D 15/02; G09F 1/02

(52) U.S. Cl. CPC B42D 15/02; G09F 1/02

(57) ABSTRACT

A tradesman trading card package for promoting various trades comprises at least one trading card with a picture of a tradesman one side of the card, information on the one side of the card describing the tradesman including name, profession, specialty and license number, and three columns on an opposite side of the card describing work experience including year obtained, organization and qualification. The tradesman trading cards are packaged according to geographical areas to be distributed to consumers in those geographical areas.

### CROSS-REFERENCE TO RELATED APPLICATIONS

This application claims the benefit of U.S. Provisional Application No. 62/503,406, file on May 9, 2017.

### BACKGROUND OF THE INVENTION

### 1. Field of Invention

The present general inventive concept relates to tradesmen advertising and awareness, and, more particularly, to trading cards used for tradesmen.

### 2. Background of the Invention

Trading cards for athletics have been widely known for a long time. Typically, cards were packaged with a stick of bubble gum and sold to children. These were for the most popular spectator sports including baseball, basketball and football. More recently an industry has sprung up concerning the collection of trading cards in a more diversified collections of sports and non-sports, usually sold without any bubble gum, and purchased, held and traded as investment opportunities. Such collecting of trading cards came to be appreciated as a challenging activity, as one tries to determine what cards will appreciate the most over time.

Additionally, there has been a growing trend in the United States away from the Trades as a career. Students generally have preferred to pursue careers in the professional fields such as Law, Engineering, Accounting and Medicine. In spite of the lack of qualified candidates in various trades, there is a great demand for skilled tradesmen including plumbers, electricians, carpenters, masons, mechanics, repair shop professionals, contractors, millwrights, trim carpenters, welders, boilermakers, machine shop, iron workers, concrete, architectural masons, drywall installers, painters & paper hangers, insulation installers, sheetmetal/HVAC, roofers, equipment operators, electricians fire alarms, and other professions. Moreover, newer tradesmen may not be as knowledgeable in how to communicate to the public regarding their particular skillsets and experience.

In light of the above, there is a need for trading cards that can provide information regarding skilled tradesmen. These cards can provide information to general contractors, subcontractors, businesses and homeowners who are looking for the best people to perform these tasks. Moreover, these trading cards can also be collected by students and children as a means to glorify the profession in order to draw more young people into these fields, which can satisfy a growing societal need. The cards may also be collected by the general population. And, as the recognition of particular “stars” in the trade fields becomes pervasive and appreciated by the general population, the value of their individual trading cards can similarly rise.

### SUMMARY OF THE INVENTION

Embodiments of the present general inventive concept provide a tradesmen trading card package for promoting various trades comprising: at least one trading card with a picture of a tradesman on one side of the card; information on the one side of the card describing the tradesman including name, profession, specialty and license number; and at least one column on an opposite side of the card describing work experience including year obtained, organization and qualifications; wherein the tradesmen trading cards are packaged according to a geographical area of the tradesman described in the card to be distributed to consumers in those geographical areas.

Further embodiments of the present general inventive concept provide a tradesmen trading card for promoting various trades comprising: a picture of a tradesman on one side of the trading card; information on the one side of the card describing the tradesman including name, profession, specialty and license number; and at least one column on an opposite side of the card describing work experience including year obtained, organization and qualifications.

Further embodiments of the present general inventive concept provide a tradesmen trading card system for promoting various trades comprising: trading cards describing one tradesman on each card with information on the cards including a picture of the tradesman, name, profession, specialty, location and experience; a central organizing body for determining which tradesmen may qualify to be included on a card, the content of the cards in general, and the specific information for each tradesman; and a distribution system for the trading cards wherein the cards of a tradesman in a geographical area are distributed only to consumers in that geographical area.

### BRIEF DESCRIPTION OF THE DRAWINGS

Example embodiments of the present general inventive concept will become more clearly understood from the following detailed description of the present general inventive concept read together with the drawings in which:

FIG. 1 is a front view of the front face of a Tradesmen Trading Card according to an example embodiment of the present general inventive concept.

FIG. 2 is a front view of the back face of a Tradesmen Trading Card according to an example embodiment of the present general inventive concept.

### DETAILED DESCRIPTION OF THE INVENTION

Reference will now be made to the example embodiments of the present general inventive concept, examples of which are illustrated in the accompanying drawing(s) and illustration(s). The example embodiments are described herein in order to explain the present general inventive concept by referring to the figure(s). The following detailed description is provided to assist the reader in gaining a comprehensive understanding of the structures described herein. Accordingly, various changes, modification, and equivalents of the structures and techniques described herein will be suggested to those of ordinary skill in the art. The descriptions are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various examples of the present general inventive concept, tradesmen trading cards is disclosed. The example embodiments described herein are described with reference to a particular layout for the cards. However, those skilled in the art will recognize that the present general inventive concept may be implemented using other layouts.

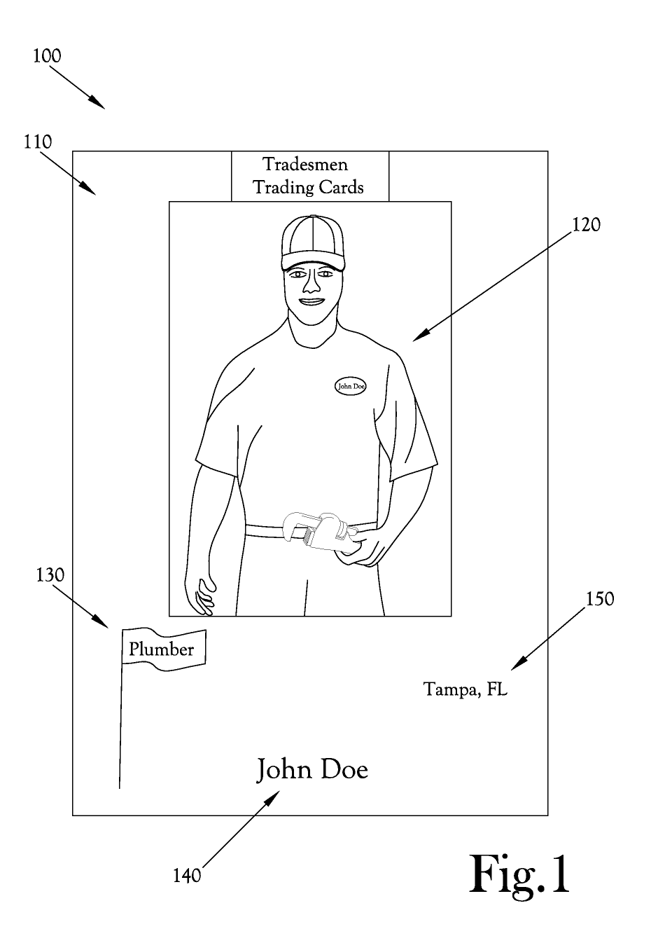

With reference to FIG. 1, in one embodiment, a general schematic view of the front face 110 of the tradesmen trading cards 100 is shown. The front face 110 of each of the tradesmen trading cards 100 will generally show a picture 120 of the individual tradesman. The picture 120 can be a head and shoulders view or a full body shot, but it should be clearly visible and may show the individual tradesman participating in his/her particular profession 130. Below the picture 120 may be the tradesman name 140 as well as a field on the bottom left listing their profession 130 and/or their particular skill or specialty. On the bottom right of each of the tradesmen trading cards 100 may be their geographical location where applicable. The dimensions of the tradesmen trading cards 100 may be 2.5 inches by 3.5 inches or 3 inches by 5 inches, although other dimensions are also possible.

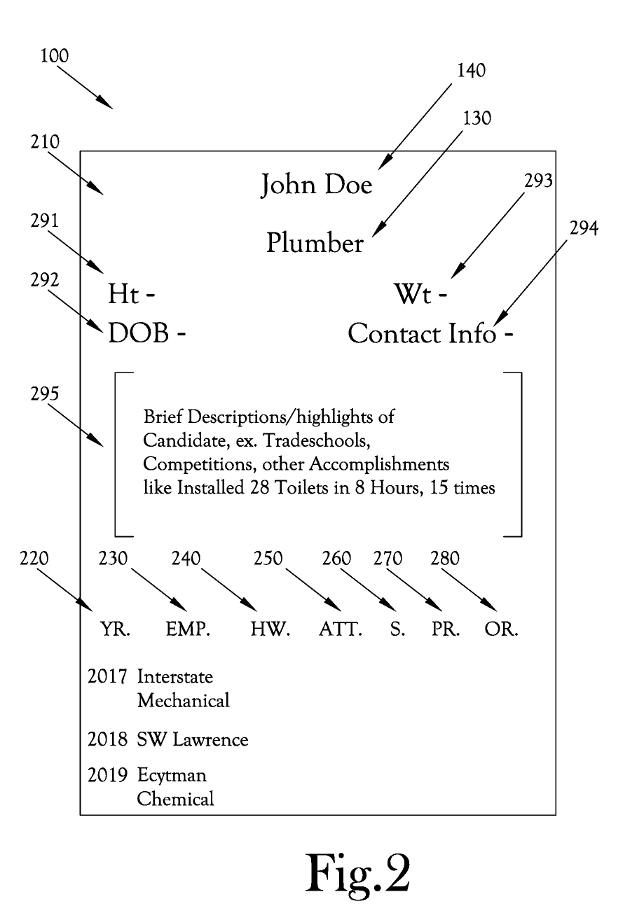

FIG. 2 shows a general schematic view of the back face 210 of the tradesmen trading cards 100. The information found here would be considered the “statistics” of the tradesmen or general information/qualifications of tradesmen for distribution in local markets, to draw a parallel with trading cards in the athletic fields, such as baseball, football, etc. A descriptive block 295 is shown in the center of the back face 210. In the left column of the back face 210 tradesmen trading cards 100, the year or years (abbreviated Yr.) 220 particular experience was obtained are listed in a vertical orientation. In the column next to the years 220, the job held or companies (abbreviated Emp.) 230 where the tradesman worked is listed in a vertical orientation. These may also include schools or other places where the tradesman gained the experience.

As shown in FIG. 2, additional columns may include hours worked (abbreviated as HW) 240, attendance (abbreviated as Att.) 250, skill percentage (abbreviated as S.) 260, production rating (abbreviated as Pr.) 270 and overall rating (abbreviated as OR) 280, which are correlated with the columns of the previous entries. Hours worked 240 is the total number of hours worked in a year. Attendance 250 is the days worked divided by the working days in a year. Skill 260 is a percentage based on the level of skill in a trade and encompasses every aspect of the trade, for example, versatility between residential and commercial work. Production rating 270 is factual, numerical data collected from contractors, unions, public organizations, previous employers, other tradesmen, or home owners. Overall rating 280 is a number on the scale of 1-100. This may be considered the rating that determines worthiness. For example, two tradesmen may have many of the same characteristics, but one may have worked for fewer employers, and this could be considered an indication of loyalty. Although not shown, it is also possible to list the qualifications that the tradesman held while performing the task(s) is listed in a vertical orientation. These may include descriptive terms such as master plumber, journeyman, apprentice, intern, etc., and may also include license number where applicable.

Also shown in FIG. 2, the tradesman name 140 as well as their profession 130, may be repeated on the back face 210 of the tradesmen trading cards 100. Under that information may include the tradesman height 291, weight 293, date of birth 292 and contact information 294.

Unlike professional sports, where there is one central organization which governs the players and sport, such as Major League Baseball or the National Basketball Association, there is no single organization for the Trades. In order to determine who is qualified to have a card, the type of experience that should be listed on the tradesmen trading cards 100 generally, and the specific information listed for each tradesman, for example, a central organizing body may be created. This organization will effectively certify to the general public that these tradesmen have sufficient skillsets and experience to be considered valuable workers in their field, and that the tradesmen have had extensive background checks performed on them. Additionally, the organization may put out a publication that can be purchased which lists the current value of each card for trade. Information for populating the tradesmen trading cards 100 may arise from contractors in the field, unions or other public organizations, previous employers, or information provided by the individuals themselves. Moreover, competitions for tradesmen are known in the art, and the results of these competitions can further be used for certification purposes and can be listed as part of the tradesman's statistics as shown on the back face 210 of the tradesmen trading cards 100.

The certification discussed above is to be considered a minimum requirement to be able to participate in the tradesmen trading cards 100 program, however. The value of each tradesmen trading cards 100 will depend on not only the skill of the tradesman, but more particularly to how much the card is worth to people who collect them, which can come from customer feedback, or sales in general. This information regarding individual tradesmen trading cards 100 values can be collected and published in various publications. Locally-known tradesmen may likely only have a minimal following, at least initially. But, as the tradesman gets more experience and recognition in his field, his value can become known to people outside of his local area, and thus, the value of his tradesmen trading cards 100 will go up proportionally. By drawing attention to these well-known workers, the tradesmen trading cards 100 system will tend to bring more notoriety to the profession as a whole. This could also serve to drive up the salaries of these skilled workers, which will be effective in bringing more young people into the profession.

Additionally, the tradesmen trading cards 100 may be used by local homeowners who are simply interested in having a local list/card collection of tradesmen who can assist them with various projects around the house, such as fixing plumbing leaks and installing new electrical devices. To facilitate this, the tradesmen trading cards 100 may be packaged according to geographical areas. These tasks can generally be handled by a large number of tradesmen, and do not require an excessive amount of experience. The homeowners may only wish to have a complete “lineup” of workers who can handle the voluminous number of mundane tasks that may arise, and can collect tradesmen trading cards 100 for these workers. The homeowner can rely on the certification by the central organizing body that these tradesmen are competent and professional. Similarly, these “local” tradesmen may have no wish to expand their operation outside of their town or region, but they may still gain value from the tradesmen trading cards 100 program by being able to draw more clients from their immediate area.

On the contrary, a homeowner may require a very unusual skill which may be hard to find in their local area. The specialties may be confined to only a handful of tradesmen. For example, expertise in renovating 19^{th} century Victorian houses may be a particular required skill. This specialty may be listed on the front face of the tradesmen trading cards 100 under the specialty field. The homeowner or contractor will want to find the right person for this job, and will likely be willing to pay a higher price for their services and may expect to get someone outside of his local area. As such they will want to do research regarding the value of the specialist's card to determine if they will be the right person for the job.

While there have been described what are considered to be preferred embodiments of the present invention, it will be readily appreciated by those skilled in the art that modifications can be made without departing from the scope of the teachings herein. Numerous variations, modification, and additional embodiments are possible, and, accordingly, all such variations, modifications, and embodiments are to be regarded as being within the spirit and scope of the present general inventive concept. For example, while the embodiments described above were to physical cards, they could also be implemented in a virtual environment such as on a computer or a cell phone application.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

Having thus described the aforementioned invention, what is claimed is:

1. A tradesmen trading card package for promoting various trades comprising:
at least one trading card with a picture of a tradesman on one side of the card;
information on the one side of the card describing the tradesman including name, profession, specialty and license number; and
at least one column on an opposite side of the card describing work experience including year obtained, organization and qualifications;
wherein the tradesmen trading cards are packaged according to a geographical area of the tradesman described in the card to be distributed to consumers in those geographical areas.

2. A tradesmen trading card for promoting various trades comprising:
a picture of a tradesman on one side of the trading card;
information on the one side of the card describing the tradesman including name, profession, specialty and license number; and
at least one column on an opposite side of the card describing work experience including year obtained, organization and qualifications.

3. A tradesmen trading card system for promoting various trades comprising:
trading cards describing one tradesman on each card with information on the cards including a picture of the tradesman, name, profession, specialty, location and experience;
a central organizing body for determining which tradesmen may qualify to be included on a card, the content of the cards in general, and the specific information for each tradesman;
a distribution system for the trading cards wherein the cards of a tradesman in a geographical area are distributed only to consumers in that geographical area.
